(19) United States
(12) Patent Application Publication
(10) Pub. No.: US 2009/0327859 A1
(43) Pub. Date: Dec. 31, 2009

(54) METHOD AND SYSTEM FOR UTILIZING WEB DOCUMENT LAYOUT AND PRESENTATION TO IMPROVE USER EXPERIENCE IN WEB SEARCH

(75) Inventors: Marcin M. Kadluczka, San Jose, CA (US); Konstantinos Tsioutsiouliklis, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/147,338

(22) Filed: Jun. 26, 2008

(51) Int. Cl. G06F 3/14

(52) U.S. Cl. 715/234

(57) ABSTRACT

Methods and systems are provided that may be used to characterize in some manner the performance that a user may experience when accessing at least one web document. An exemplary method may include processing the at least one web document to assess a user experience associated with the at least one web document based, at least in part, on at least one predefined user experience criterion associated with the at least one web document, and evaluating the at least one web document based, at least in part, on the user experience.

### BACKGROUND

1. Field

The subject matter disclosed herein relates to network related data communications and processing, and more particularly to information extraction and information retrieval methods and systems.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided which allow for the copious amounts of information to be searched through in an efficient manner. For example, service providers may allow for users to search the World Wide Web or other like networks using search engines. Similar tools or services may allow for one or more databases or other like data repositories to be searched.

There is a wide variety of web documents available on the World Wide Web. Some of these web documents may contain information of interest such as, text or other descriptions relating to a certain topic. Such web documents can be presented in a variety of different formats.

With so much information being available, there is a continuing need for methods and systems that allow for relevant information to be identified and presented in an efficient manner.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a block diagram illustrating certain processes, functions and/or other like resources of an exemplary computing environment including an information integration system having a web document user experience characterizer.

FIGS. 2 and 3 are flow diagrams illustrating exemplary methods that may, for example, be implemented at least in part using the information integration system of FIG. 1.

FIG. 4 is an illustrative diagram showing portions of a search result display that may be associated with the information integration system of FIG. 1.

FIG. 5 illustrates a computing platform for assessing a user experience for at least one web document.

### DETAILED DESCRIPTION

Some exemplary methods and systems are described herein that may be used to establish or otherwise characterize in some manner the performance that a user may experience when accessing a web document. The resulting user experience information may be used or otherwise considered in some manner in at least one other process. By way of example but not limitation, the resulting user experience information may be used in an information extraction engine or other like process to help further classify web documents in some manner with respect to the user, and/or in a search engine or other like process to help further rank or otherwise identify or arrange search results in response to a user's search query.

The Internet is a worldwide system of computer networks and is a public, self-sustaining facility that is accessible to tens of millions of people worldwide. Currently, the most widely used part of the Internet appears to be the World Wide Web, often abbreviated “WWW” or simply referred to as just “the web.” The web may be considered an Internet service organizing information through the use of hypermedia. Here, for example, the HyperText Markup Language (HTML) may be used to specify the contents and format of a web document (e.g., a web page).

Unless specifically stated, a web document may refer to either the source code for a particular web page or the web page itself. A web document may, for example, include embedded references to images, audio, video, other web documents, etc., just to name a few examples. One common type of reference used to identify and locate resources on the web is a Uniform Resource Locator (URL).

Asynchronous JavaScript and Extensible Markup Language (XML) (collectively, “Ajax”) events may refer to certain interactions with a server that may take place when a web document is accessed. Here, Ajax may comprise a group of inter-related web development techniques used for creating interactive web applications.

“JavaScript” may refer to a scripting language that may be used for client-side web development. JavaScript may be utilized to write functions that are embedded in or included from HTML pages and interact with the Document Object Model (DOM) of a web page. For example, JavaScript may be utilized for opening or popping up a new web browser window with programmatic control over size, position and “look” of such a new window such as, for example, whether menus and toolbars are visible in such a new web browser. JavaScript may also be utilized, for example, to alter images as a mouse cursor moves over them in an effort to draw a user's attention to certain links that may be displayed as graphical elements.

In the context of the web, a user may “browse” for information by following references that may be embedded in each of the documents, for example, using hyperlinks provided via the HyperText Transfer Protocol (HTTP) or other like protocol.

Through the use of the Web, users may have access to millions of pages of information. However, because there is so little organization to the web, at times it may be extremely difficult for users to locate the particular web documents that contain the information that may be of interest to them. To address this problem, a mechanism known as a “search engine” may be employed to index a large number of web documents and provide an interface that may be used to search the indexed information, for example, by entering certain words or phrases to be queried.

The search engine may, for example, be part of an information integration system that may also include a “crawler” or other process that may “crawl” the Internet in some manner to locate web documents. Upon locating a web document, the crawler may store the document's URL, and possibly follow hyperlinks associated with the web document, for example to locate other web documents.

An information integration system may also include an information extraction engine or other like process that may be adapted to extract and/or otherwise index certain information about the web documents that were located by the crawler. Such index information may, for example, be generated based on the contents of an HTML file associated with a web document and may be included in a stored index, for example within a database.

An information integration system may also include a user experience characterizer or other like process that may be adapted to render or emulate performance of a particular web document as would be seen by a user utilizing a web browser to view the web document.

A search engine may allow users to search the database, for example, via a user interface that allows a user to input or otherwise specify search query terms (e.g., keywords or other like criteria) and receive and view search results. A search engine may, for example, present search result summaries in a particular order as may be indicated by a ranking function or other like process. A search result summary may, for example, include information about a web document such as a title, an abstract, a link, and/or possibly one or more other related objects that may assist a user in deciding whether to access the web document.

Should a user decide to access a web document based on the search result summary, then the user may, through the user interface, indicate such desire by initiating access to the web document. For example, a user may click-on on link or other like selectable mechanism within a search result summary to initiate access to the web document through a browser or other like process that may be used to access and render web documents. The user interface may, for example, itself be a web document that is accessed and rendered through the browser or other like process.

With so many websites and web documents being available and with varying hardware and software configurations, it may be beneficial to identify which web documents may lead to a desired user experience and which may not lead to a desired user experience. By way of example but not limitation, in certain situations it may be beneficial to determine (e.g., classify, rank, characterize) which web documents may not meet performance or other user experience expectations if selected by the user. Such performance may, for example, be affected by server, network, client, file, and/or like processes and/or the software, firmware, and/or hardware resources associated therewith.

A user experience is determined for a particular web document that may be included within a searchable database of web documents. The searchable database of web documents may be searched by, for example, a user searching for key words or a search string via an Internet search engine. The Internet search engine may rank web documents pertaining to the key words or search string according to certain criteria, such as relevance of information presented on the web document and also according to an overall user experience associated with the web document.

A negative user experience may cause a web document that otherwise presents relevant information to have a lower ranking for the key words or search string, whereas a positive user experience may cause a web document to have a relatively higher associated ranking. A user experience for a particular web document represents what a hypothetical user who views the web document is likely to think about the web document. For example, if text is presented in a clear and easy-to-read format on a web document, a positive user experience might be determined for such web document. On the other hand, if certain aspects of the web document are likely to be distracting or annoying to such hypothetical user who views the web document, a negative user experience may result. Examples of aspects contributing to such a negative user experience may include, for example, excessive movement of objects on a web document, text that is difficult to read, text placed in unusual positions on the web document, pop-up or pop-under windows that automatically show up upon visiting the web document or clicking on items or links on the web document.

Additional layout-relating aspects of a web document that may contribute to a negative user experience also include a quantity of visible objects on such web document, as well as transparent and opaque objects on such web document. Certain events associated with a web document may also contribute to a negative user experience, such as a quantity and type of JavaScript events that take place on the web document, links overlapping between tags and JavaScript events, as well as Ajax (asynchronous JavaScript and XML (Extensible Markup Language)) events.

In one embodiment, Ajax may comprise a group of inter-related web development techniques used for creating interactive web applications. In particular implementations, although claimed subject matter is not limited in this respect, Ajax may increase responsiveness of web pages by exchanging small amounts of data with a server so that entire web pages do not have to be reloaded each time there is a need to fetch data from the server. Such a characteristic may increase such a web page's interactivity, speed, functionality and usability. Ajax may be asynchronous, in that extra data is requested from the server and loaded in the background without interfering with the display and behavior of the existing page.

Ajax events may comprise events resulting in information being periodically exchanged with a remote server. For example, moving a computer mouse so that a browser cursor is over certain text or a portion of a web document may result in certain information being sent to/from a remote server. Such Ajax events may cause such a web document to load more slowly and/or be more difficult to peruse. In some implementations such as, for example, a user utilizing a web browser program via an older or out-of-date computer, such Ajax events may utilize a relatively large amount of processing power, causing the browser program to either crash or run slower than usual.

Once web documents are identified in this manner the resulting user experience information may, for example, be considered when generating the search results.

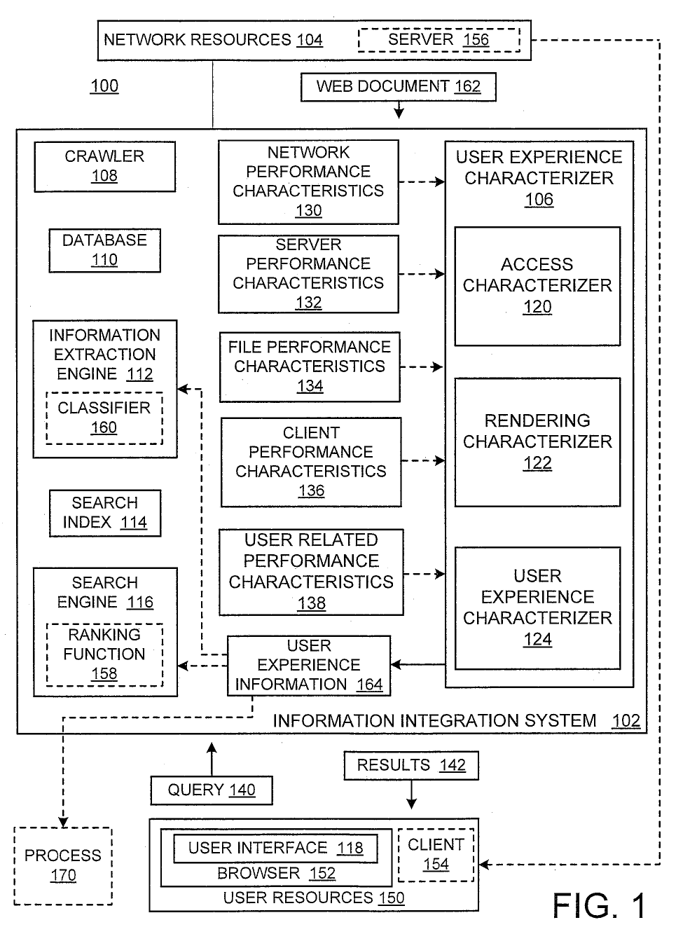

Attention is now drawn to FIG. 1, which is a block diagram illustrating certain processes associated with an exemplary computing environment 100 having an Information Integration System (IIS) 102. The context in which such an IIS may be implemented may vary. For non-limiting examples, an IIS such as IIS 102 may be implemented for public or private search engines, job portals, shopping search sites, travel search sites, RSS (Really Simple Syndication) based applications and sites, and the like. In certain implementations, IIS 102 may be implemented in the context of a World Wide Web (WWW) search system, for purposes of an example. In certain implementations, IIS 102 may be implemented in the context of private enterprise networks (e.g., intranets), as well as the public network of networks (i.e., the Internet).

As illustrated in FIG. 1, IIS 102 may be operatively coupled to network resources 104 and user resources 150. IIS 102 may include a crawler 108 that may access network resources 104, which may include, for example, the Internet and the World Wide Web (WWW), one or more servers, etc. IIS 102 may include a database 110, an information extraction engine 112, a search engine 116 backed, for example, by a search index 114 and possibly associated with a user interface 118 through which a query 140 may be initiated and results 142 provided to the user. Here, for example, user interface 118 may be provided within a browser or other like process of user resources 150. In certain implementations user resources 150 may, for example, include a client 154 or other like process adapted to operatively couple to a server 156 or other like process of network resources 104.

Crawler 108 may be adapted to locate web documents such as, for example, web documents associated with websites, etc. In one particular implementation, crawler 108 may implement a “Mozilla-based crawl” in which, for example, fetching is performed based on a Mozilla Foundation source code or a modification of Mozilla Foundation source code. Crawler 108 may also follow one or more hyperlinks associated with a web document to locate other web documents. Upon locating a web document, crawler 108 may, for example, store the web document's URL and/or other information in database 110. Crawler 108 may, for example, store all or part of a web document (e.g., HTML, XML, object, and/or the like) and/or a URL or other like link information in database 110.

Information extraction engine 112 may generate at least one search index 114 based on the information in database 110. Information extraction engine 112 may, for example, be adapted to extract or otherwise identify specific type(s) of information and/or content in web documents such as, for example, job titles, job locations, experience required, etc., using a classifier 160 or other like process. Search index 114 may, for example, be accessed by search engine 116 during a search based on query 140. In certain implementations, at least a portion of search index 114 may be included in database 110.

IIS 102 may also include or otherwise be operatively coupled to a user experience characterizer 106. As shown user experience characterizer 106 may, for example, include processes such as an access characterizer 120, a rendering characterizer 122, and/or a user experience characterizer 124. User experience classifier 106 may also include or otherwise access certain network performance characteristics 130, server performance characteristics 132, file performance characteristics 134, client performance characteristics 136, and/or user related performance characteristics 138. User experience characterizer 106 may, for example, generate user experience information 164. As illustrated, by way of example but not limitation, user experience information 164 may be accessed or otherwise used by information extraction engine 112, search engine 116, and/or other like process within IIS 102 and/or possibly at least one process 170 that may be outside of IIS 102.

Access characterizer 120 may, for example, be adapted to characterize the “accessibility” of web document 162 as may be experienced by a user of computing environment 100. For example, access characterizer 120 may be adapted to establish (e.g., measure, determine, and/or otherwise estimate) certain performance characteristics that may be experienced by a user upon initiating access to web document 162. Such performance characteristics may include, for example, potential latency characteristics associated with various network hardware and software resources that may operatively couple client 154 and server 156 together to transfer one or more data files associated with web document 162. Thus, in certain exemplary implementations, access characterizer 120 may take into consideration applicable network performance characteristics 130, server performance characteristics 132, file performance characteristics 134, and/or other applicable performance characteristics to characterize such web document accessibility performance.

Web document accessibility performance may vary from one user (e.g., client) to another and/or one website or web document (e.g., data file, server) to another as different hardware and/or software resources may be involved. For example, some users may be able to access a data file faster than others as a result of having a higher speed data connection (e.g., broadband versus dial-up modem, etc.). For example, some servers may provide for faster downloading of data files due to higher bandwidth connections, replication, strategic locations, etc. For example, some web documents may be smaller in size (data) and therefore faster to access than other larger sized (data) web documents.

In certain exemplary implementations, crawler 108 or other like process may be adapted to establish network performance characteristics 130, server performance characteristics 132, file performance characteristics 134, and/or other applicable performance characteristics as needed to characterize such web document accessibility performance. Thus, for example, network performance characteristics 130 server performance characteristics 132, file performance characteristics 134, and/or other applicable performance characteristics as needed to characterize such web document accessibility performance may be established (e.g., measured, determined, and/or otherwise estimated) by crawler 108 while locating and/or accessing a web document. Here, for example, crawler 108 may be adapted to simulate, emulate or otherwise take into consideration different communication capabilities as might be applicable to one or more specific users and/or certain types of users, clients, user resources, etc.

Rendering characterizer 122 may be adapted to characterize a rendering and/or presentation capability for web document 162 within computing environment 100. For example, rendering characterizer 122 may be adapted to establish (e.g., measure, determine, and/or otherwise estimate) certain performance characteristics that may be experienced by a user upon accessing one or more data files associated with web document 162. Such performance characteristics may include, for example, characteristics associated with the browser or other like software and hardware client resources that may be adapted to “render” the web document. Rendering characterizer 122 may effectively emulate the web document to determine a layout of what the web document would look like if displayed in a window of a web browser application program. Such rendering may, for example, include displaying visual information, reproducing audio or video information, presenting objects, presenting interactive user input/output features, providing additional data access or communication features, and/or the like as may be operatively associated with a web document. Such rendering may also include determining whether any events, such as JavaScript events, are implemented by the web document as well as an outcome of such JavaScript events. In certain exemplary implementations, for example, access characterizer 120 may take into consideration applicable file performance characteristics 134, client performance characteristics 136, and/or other applicable performance characteristics as needed to characterize such web document rendering performance.

Web document rendering performance may vary from one user (e.g., client) to another and/or one web document to another as different hardware and/or software resources may be involved. For example, some user resources may have fast hardware and/or different software configurations that may be able to render or otherwise process the accessed data file(s) faster than others. For example, some web documents may be rendered or otherwise processed faster than others due to differences in complexity, size, number of files, user interface mechanisms, embedded sections (e.g., advertisements, audio content, video content, security features, etc), and/or the like.

In certain exemplary implementations, crawler 108, search engine 116 or other like process may be adapted to establish file performance characteristics 134, client performance characteristics 136, and/or other applicable performance characteristics as needed to characterize such web document rendering performance. Thus, for example, file performance characteristics 134, client performance characteristics 136, and/or other applicable performance characteristics as needed to characterize such web document rendering performance may be established (e.g., measured, determined, and/or otherwise estimated) by crawler 108 while locating and/or accessing a web document. Here, for example, crawler 108 may be adapted to simulate, emulate or otherwise take into consideration different rendering capabilities as might be applicable to one or more specific users and/or certain types of users, clients, user resources, etc. Thus, in certain implementations, all or portions of a web document may be rendered by crawler 108 in some manner to establish such web document rendering performance as might subsequently be experienced by a user.

User experience characterizer 124 may be adapted to characterize certain user experiences (e.g., acceptable performance levels, interactivity, display of information, etc.) associated with the access, presentation, and/or use of a web document, such as website or web document, by a user. For example, user experience characterizer 124 may be adapted to receive, access, and/or establish (e.g., measure, determine, and/or otherwise estimate) certain performance characteristics that may be acceptable or otherwise perceived to be desirable (or unacceptable or otherwise perceived to be undesirable) to a user. Such performance characteristics may include, for example, acceptable user latency threshold characteristics, and/or perceived desired (or undesired) user interactive or other like web documents and/or web document features, a layout and display of text and/or other objects in the web document, a presence of certain events, such as JavaScript events, in the web document. Thus, in certain exemplary implementations, user experience characterizer 124 may take into consideration applicable file performance characteristics 134, user related performance characteristics 138, and/or other applicable performance characteristics as needed to characterize such user related performance associated with a web document.

The user related performance may vary from one user to another and/or for a user from one web document to another, for example, due to inherent differences. For example, certain users may have more patience than others and as such may accept longer access or rendering delays. For example, certain users may have more patience for such delays as might be experienced for certain web documents. Here, for example, a user may be more likely to wait for a web document associated with their bank account to be accessed and rendered than they might be for a more generic or non-specific web document.

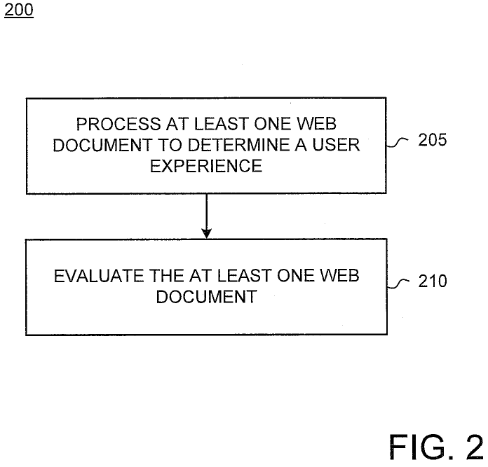

FIG. 2 illustrates a flow diagram 200 illustrating an exemplary method that may, for example, be implemented at least in part using the information integration system of FIG. 1. First, at operation 205, at least one web document is processed to assess/determine a user experience associated with the at least one web document. Such processing of the at least one web document may comprise emulating the at least one web document. Such a user experience may be assessed based, at least in part, on at least one predefined user experience criterion associated with such an at least one web document. Such an at least one predefined user experience criterion may comprise at least one of: presentation characteristics, layout characteristics, and/or predetermined events corresponding to such an at least one web document.

Such presentation characteristics may comprise at least one of: moving objects, position of text, icons adapted to move with a cursor if such an at least one web document is accessed, pop-up windows, and/or pop-under windows. Such layout characteristics, as discussed above, may comprise at least one of: a presentation style of visible objects and a quantity of at least one of: visible objects, transparent objects, and/or opaque objects. Such predetermined events, as discussed above, may comprise at least one of: a quantity of JavaScript events, a type of such JavaScript events, a quantity of links overlapping between tags and such JavaScript events, and/or a quantity of Ajax events.

After such a user experience has been determined, processing proceeds to operation 210, where such at least one web document is evaluated. Such an at least one web document may be evaluated based, at least in part, on such user experience. A web document ranking for the at least one web document may be modified based, at least in part, on such evaluating of the at least one web document.

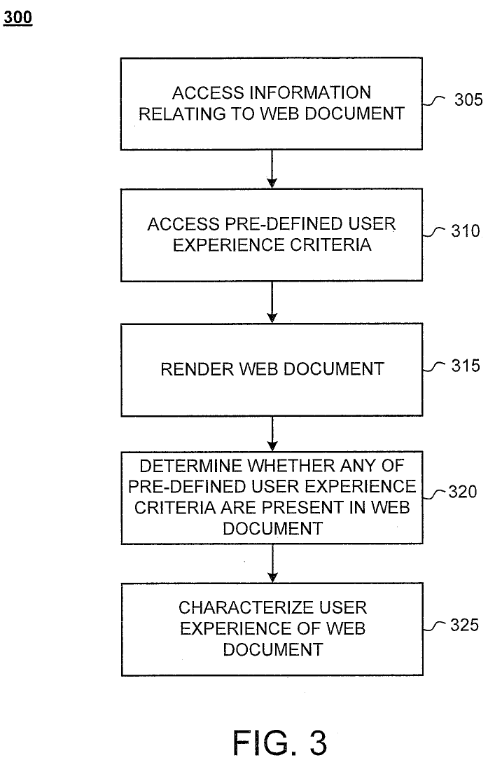

FIG. 3 illustrates a flow diagram 300 illustrating an exemplary method that may, for example, be implemented at least in part using the information integration system of FIG. 1. First, at operation 305, information relating to a web document is accessed. Such information may include, for example, HyperText Markup Language (HTML) code or other code for the web document. Next, pre-defined user experience criteria are accessed at operation 310. Such pre-defined user experience criteria may be utilized to determine an overall user experience for a particular web document.

Such pre-defined user experience criteria may include criteria relating to a layout and display of text, objects, or other items on a web document. For example, if some web documents are accessed via a web browser, “flying objects,” i.e., moving objects displayed on a web document, may be present. Such flying objects can be distracting to a user and potentially annoying. There may also be icons that attach themselves to a displayed cursor. For example, there may be an image, such as a sword, that attaches itself to a cursor displayed in a web browser, and moves whenever a user moves such cursor, e.g., by moving a corresponding computer mouse. In the event that a user accesses a web document while searching for information of a topic of interest, such flying objects and objects attaching themselves to the cursor may be distracting and annoying, and may present an overall negative user experience.

Pre-defined user experience criteria may include criteria relating to presentation of text on a web document. For example, a web document in which all of the text is the same color and same size may be easy for a user to peruse. However, such text may be difficult for a user to read if, for example, the text is too small or too large. Moreover, an overall color scheme may also detract from a user experience. For example, certain colors may be difficult to read. If, for example, the background of a web document is bright yellow and text is displayed in a bright neon green color, such text may be difficult to discern because of insufficient contrast between the text and the background. Moreover, the position of the text on the web document also has a bearing upon whether it may contribute to a negative user experience. For example, if too much text is presented on a web page, the user experience may be degraded. For example, it may be known that some users searching for specific information may only read the top portion of a web page. Accordingly, if relevant information is presented at the bottom of the web document, e.g., “below the fold,” i.e., below the bottom of the initial web browser view such that a user would need to scroll down the web document to find the relevant information, such presentation of information may contribute to a negative user experience.

Pre-defined user experience criteria may also include information relating to a quantity of visible objects and how they are presented. For example, if a web document contains a large quantity of images, such as 100 images, such web document may be annoying to a user, particularly if relevant text is disposed between each of the images. Moreover, if such a web document includes an inordinate quantity of paragraphs, it may also be distracting to a user. For example, a web document with 300 paragraphs of text may be annoying to a user because it may be difficult for the user to scroll through to find relevant information. A large amount of information presented in the form of one or more tables may also be distracting or annoying to a user. The presence of transparent and opaque objects on the web document may be distracting as well.

Another type of pre-defined user experience criteria includes a presence of pop-up and/or pop-under windows on the web document. A pop-up window may comprise a web browser window that automatically opens up on top of an initial web browser window upon visiting a particular web document. A pop-under window may comprise a web browser window that automatically opens underneath an initial web browser window upon visiting a particular web document. Online advertisements may be displayed on such pop-up and pop-under windows and may be annoying and/or distracting to users. Moreover, such pop-up and pop-under windows may cause a user's web browser application program to crash.

Pre-defined user experience criteria may include additional criteria relating to a presence for certain pre-defined events. For example, a presence of JavaScript events on a web document may be considered. Factors such as quantity (e.g., a number of JavaScript events on such a web document) and type of such JavaScript events on such a web document may be considered. Some JavaScript events may be implemented if such a web document is initially loaded and others may be implemented if a user clicks on a link or other item in such a web document. Such a web document may also include links that overlap between tags and JavaScript events such that upon clicking on a link, a JavaScript event occurs. Another type of event is an “Ajax” event. An Ajax event is an event in which interaction takes place with a remote server. For example, upon dragging and dropping an item on a web document or moving a cursor over an object on the web document, an Ajax event may take place.

Such pre-defined user experience criteria, as discussed above, may be stored in a database, or memory within or accessible by computing environment 100. Referring back to FIG. 3, at operation 315 a web document is rendered. In rendering such a web document, performance of the web document and various criteria relating to layout and presentation of objects as well as the presence of certain pre-defined events, such as those discussed above, may be determined. By rendering such a web document, information relating to characteristics of such a web document that a typical user might encounter upon viewing such a web document is effectively determined. Such characteristics of such a web document may include any, or all, of such pre-defined user experience criteria, as discussed above.

Next, at operation 320, a determination is made of whether any of the pre-defined user experience criteria are present in such a web document. Finally, at operation 325, a user experience for the web document is determined. Such a determined user experience may represent how satisfied overall a user is likely to be upon visiting the web document. For example, a user experience for a particular web document may be represented via a numerical score. In one implementation, the score may be defined on a scale between a predetermined high value, such as 100.0, and a predetermined low value, such as 0.0. It should be appreciated that a scale between 100.0 and 0.0 is merely an example, and that a wide array of different scales may be used. In one implementation, a relatively high score, such as a score of 90.0, may indicate that the web document is associated with a generally positive user experience, whereas a relatively low score, such as a score of 10.0, may indicate that the web document is associated with a generally negative user experience.

Some search engines focus only on improving the relevance of search results to a user's search query, i.e., key words or search string. However, upon determining a user experience for a web document, a combination of the relevance and user experience may be determined when determining rankings of web documents pertaining to a user's search query. For example, if the relevance of the web document has previously been determined, the user experience of the web document may be utilized to alter an overall search engine ranking for the web document.

By way of example but not limitation, the user experience information may be used by a search engine as an input to a ranking function to help identify search results and/or otherwise establish an order for search results associated with a query. By way of example but not limitation, the user experience information may be used by an information extraction engine as an input to a classifier to help classify a web document in a search index. The classifier may be utilized to indicate a general type that the web document is, such as whether it relates to shopping or financial information.

The layout of web documents may sometimes be indicative of a content type of the web document. For example, web spammers may use hidden text and pop-up windows. Non-professional web documents may often have a poor design and layout. Also, Cascading Style Sheets (CSS) pages may indicate the content type of the page. Web spammers may often use the same style sheet across their web documents. Accordingly, the presence of the pre-defined user experience criteria at operation 320 may be utilized to help classify the web document.

The information in the pre-defined user experience database may be periodically updated to more precisely determine web document characteristics associated with a negative user experience. User behavior may be monitored and used as a guide for subsequent crawls and indices, i.e., databases of web documents that have been crawled. For example, if a user abandons a web document quickly, that may be a negative indication of the web document's quality and relevance. Positive feedback may be provided, however, if users are actively engaged (e.g., a relatively large quantity of mouse clicks or longer browsing times at the web document). Such user behavior may be tracked, for example, through affiliate programs, toolbars, and/or user studies.

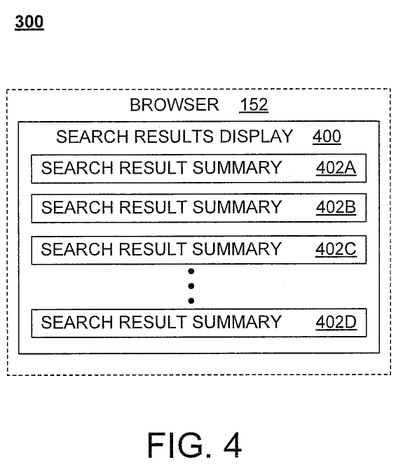

FIG. 4 is an illustrative diagram showing an exemplary search results display 400, for example, as might be shown to a user through a browser 152 or other like process. Search results summary display 400 may include a plurality of search result summaries 402 associated with a query. Here, for example, search result summaries 402A, 402B, 402C, and up through 402n are shown. This ordering may be affected by user experience information 164 (FIG. 1) and/or of operation 325 (FIG. 3). For example, search result summary 402C may have been adjusted down to the third position by the search engine as a result of a change in classification and/or ranking based on user experience information characterization that suggests search result summaries 402A and 402B may be perceived as better suited for a user.

The user may select (e.g., via browser 152) one of search result summaries or a link portion thereof to initiate access to the corresponding web document. However, if the applicable data file(s) download and/or render too slowly the user's experience may be unacceptable and may result in the user abandoning his/her attempted access or possibly the entire session with the search engine.

Search engines may, for example, include ranking functions that focus on improving the “quality” or “relevance” of search result summaries for a given query. With the exemplary methods and systems provided herein, a quality or relevance determination may (also) take into consideration the desired, potential, and/or otherwise established user experience, for example, as one or more parameters in ranking or displaying search result summaries.

The user experience information determined at operation 325 in FIG. 3, for example, may allow a search engine or other like process to consider several characteristics relating to one or more of the network, server, client, file, or user, and of which one or more may affect the accessibility, rendering, or user experience with a web document, search engine or other like process or service.

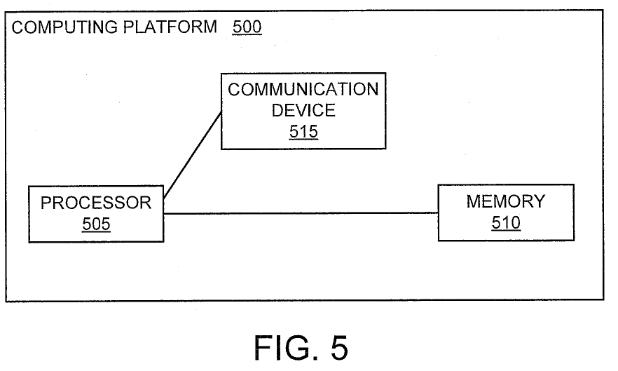

FIG. 5 illustrates a computing platform 500 for assessing a user experience for at least one web document. The computing platform 500 may include, for example, a processor 505, a memory 510, and a communication device 515. Additional elements may also be included in such computing platform, depending on the particular application.

Such memory 510 may include machine-readable instructions stored thereon which may be executed by such processor 505. Execution of such machine-readable instructions may enable such computing platform 500 to process at least one web document to assess a user experience associated with such an at least one web document based, at least in part, on at least one predefined user experience criterion. Such machine-readable instructions may enable such computing platform to evaluate such an at least one web document based, at least in part, on such a user experience.

Such machine-readable instructions may also be adapted to enable such a computing platform to emulate such an at least one web document and to modify a web document ranking for such an at least one web document based, at least in part, on evaluating of such an at least one web document.

By determining a user experience associated with a web document, such a web document may be ranked according to both relevance and overall look-and-feel. Such improved ranking may be desired by users who are accustomed to only be provided with relevant web documents for which their associated look-and-feel is not a factor as a result of a web query. Such search engine capability may breed loyalty among users and may result in them repeatedly using such search engines implementing one or more of the methods discussed herein.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method, comprising:
processing at least one web document to assess a user experience associated with the at least one web document based, at least in part, on at least one predefined user experience criterion associated with the at least one web document; and
evaluating the at least one web document based, at least in part, on the user experience.

2. The method of claim 1, wherein the processing the web document comprises emulating the at least one web document.

3. The method of claim 1, further comprising modifying a web document ranking for the at least one web document based, at least in part, on the evaluating the at least one web document.

4. The method of claim 1, wherein the at least one predefined user experience criterion comprises at least one of: presentation characteristics, layout characteristics, and/or predetermined events corresponding to the at least one web document.

5. The method of claim 4, wherein the presentation characteristics comprise at least one of: moving objects, position of text, icons adapted to move with a cursor if the at least one web document is accessed, pop-up windows, and/or pop-under windows.

6. The method of claim 4, wherein the layout characteristics comprise at least one of: a presentation style of visible objects and a quantity of at least one of: the visible objects, transparent objects, and/or opaque objects.

7. The method of claim 4, wherein the predetermined events comprise at least one of: a quantity of JavaScript events, a type of the JavaScript events, a quantity of links overlapping between tags and the JavaScript events, and/or a quantity of Ajax events.

8. The method of claim 1, wherein the at least one web document comprises at least one website page.

9. The method of claim 1, further comprising determining a user experience score for the at least one web document based, at least in part, on the user experience.

10. The method of claim 1, wherein the processing is performed within at least a portion of a computing environment comprising at least one resource selected from a group of resources comprising at least a portion of a network, a computing device, a server process, a client process, a browser process, and/or at least one data file associated with the at least one web document.

11. An article comprising: a storage medium comprising machine-readable instructions stored thereon which, if executed by a computing platform, are adapted to enable the computing platform to:
process at least one web document to assess a user experience associated with the at least one web document based, at least in part, on at least one predefined user experience criterion associated with the at least one web document; and
evaluate the at least one web document based, at least in part, on the user experience.

12. The article of claim 11, wherein the machine-readable instructions are further adapted to enable the computing platform to emulate the at least one web document.

13. The article of claim 11, wherein the machine-readable instructions are further adapted to enable the computing platform to modify a web document ranking for the at least one web document based, at least in part, on evaluating of the at least one web document.

14. The article of claim 11, wherein the machine-readable instructions are further adapted to enable the computing platform to determine a user experience score for the at least one web document based on the user experience.

15. A system comprising at least one processing unit adapted to:
process at least one web document to determine a user experience associated with the at least one web document based, at least in part, on at least one predefined user experience criterion associated with the at least one web document; and
evaluate the at least one web document based, at least in part, on the user experience.

16. The system of claim 15, wherein the at least one processing unit is further adapted to establish the at least one predefined user experience criterion.

17. The system of claim 15, wherein the at least one processing unit comprises at least one server.

18. The system of claim 15, wherein the at least one processing unit is adapted to emulate the at least one web document.

19. The system of claim 15, wherein the at least one processing unit is adapted to modify a web document ranking for the at least one web document based, at least in part, on evaluating of the at least one web document.

20. The system of claim 15, wherein the at least one processing unit is adapted to determine a user experience score for the at least one web document based on the user experience.
